(19) United States
(12) Patent Application Publication
(10) Pub. No.: US 2025/0307624 A1
(43) Pub. Date: Oct. 2, 2025

(54) OPTOELECTRONIC STOCHASTIC NEURAL NETWORK

(71) Applicant: ARTILUX, INC., MENLO PARK, CA (US)

(72) Inventors: Yun-Chung Na, San Jose, CA (US); Chih-Hao Cheng, HSINCHU COUNTY (TW)

(21) Appl. No.: 19/035,705

(22) Filed: Jan. 23, 2025

Related U.S. Application Data
(60) Provisional application No. 63/571,414, filed on Mar. 28, 2024.

(51) Int. Cl. G06N 3/067; G06N 3/047

(52) U.S. Cl. CPC G06N 3/0675; G06N 3/047

(57) ABSTRACT

Methods, apparatus, techniques, subsystems, and systems for optoelectronic stochastic neural networks are provided. In one aspect, an optoelectronic circuitry for performing computations of a neural network model includes a plurality of single-photon avalanche diodes (SPADs). The neural network model includes a plurality of layers, and each of the plurality of layers includes a plurality of neurons. Each SPAD of the plurality of SPADs is configured to: receive a respective input representing an input to a corresponding neuron of the plurality of neurons, and generate a respective output representing an output from the corresponding neuron.

### CROSS-REFERENCE TO RELATED APPLICATION

This application claims the benefit of U.S. Provisional Patent Application No. 63/571,414, filed Mar. 28, 2024, which is incorporated by reference herein in its entirety.

### TECHNICAL FIELD

The present disclosure relates to implementations of machine-learned models using optoelectronic elements.

### BACKGROUND

A neural network is a computational model designed to recognize patterns and solve complex problems by learning from data. Neural network computation can be used in applications such as artificial intelligence, image processing, natural language process, and many more.

### SUMMARY

Implementation of the present disclosure provide methods, apparatus, techniques, subsystems, and systems for optoelectronic stochastic neural networks, e.g., by implementing machine-learned models using optoelectronic elements.

One aspect of the present disclosure includes an optoelectronic circuitry for performing computations of a neural network model. The optoelectronic circuitry includes a plurality of single-photon avalanche diodes (SPADs). The neural network model includes a plurality of layers. Each of the plurality of layers includes a plurality of neurons. Each SPAD of the plurality of SPADs is configured to: receive a respective input representing an input to a corresponding neuron of the plurality of neurons, and generate a respective output representing an output from the corresponding neuron.

In some implementations, the plurality of SPADs include germanium-silicon (GeSi) SPADs.

In some implementations, the plurality of SPADs are arranged in a one-dimensional array or a two-dimensional array on a substrate.

In some implementations, the neural network model includes a stochastic neural network, and where each of the plurality of neurons is associated with a respective probability distribution for outputting a predetermined value.

In some implementations, the respective probability distribution associated with a corresponding SPAD of the plurality of SPADs is controlled by a bias applied to the corresponding SPAD.

In some implementations, the probability distribution is activated linearly by ranging the bias applied on the corresponding SPAD to be below a saturation regime of the corresponding SPAD.

In some implementations, the probability distribution is activated non-linearly by ranging the bias applied on the corresponding SPAD to be from below a saturation regime of the corresponding SPAD to beyond the saturation regime.

In some implementations, the probability distribution associated with the corresponding SPAD is further controlled by at least one of (i) a time duration of which the bias varies in time, (ii) an intensity of an optical signal that is incident on the intensity SPAD, or (iii) temperature.

In some implementations, the optoelectronic circuitry further includes: a plurality of bias circuitries electrically coupled to the plurality of SPADs, where each of the plurality of bias circuitries is configured to generate a respective bias voltage for biasing a corresponding SPAD.

In some implementations, each of the plurality of bias circuitries is configured to receive a reference voltage and an input voltage, and where the bias voltage is generated by combining a direct current (DC) component of the reference voltage and an alternating current (AC) component of the input voltage.

In some implementations, the optoelectronic circuitry further includes: a plurality of amplification circuitries electrically coupled to the plurality of SPADs, where each of the plurality of amplification circuitries is configured to generate a respective amplified voltage signal based on a corresponding output from a corresponding SPAD.

In some implementations, the optoelectronic circuitry further includes: a memory cross bar electrically coupled to the plurality of amplification circuitries, where the memory cross bar is configured to perform a voltage-to-current or a voltage-to-voltage matrix calculation based on the respective amplified voltage signals from the plurality of amplification circuitries.

In some implementations, the optoelectronic circuitry further includes: a plurality of transimpedance amplifier (TIA) circuitries configured to generate analog voltage signals based on current outputs of the memory cross bar.

In some implementations, the optoelectronic circuitry further includes: a plurality of analog-to-digital converter (ADC) circuitries configured to generate digitized voltage signals based on the analog voltage signals from the plurality of transimpedance amplifier circuitries or from voltage outputs of the memory cross bar.

Another aspect of the present disclosure features a neural network model including a plurality of layers. Each of the plurality of layers includes a plurality of neurons. Each neuron of the plurality of neurons includes a SPAD configured to: receive a bias voltage and generate an output based on a probability distribution for outputting a predetermined value, where the probability distribution is controlled by at least the bias voltage.

In some implementations, the plurality of layers includes a first layer and a second layer, and outputs of neurons of the first layer are electrically coupled to an input of each neuron of the second layer.

In some implementations, the probability distribution is further controlled by at least one of (i) a time duration of which the bias varies in values, (ii) an intensity of an optical signal that is incident on the SPAD, or (iii) temperature.

A further aspect of the present disclosure features a method for performing computations on a neural network model. The method includes: applying voltage biases to a plurality of SPADs, where each SPAD of the plurality of SPADs is a part of a neuron of a plurality of neurons in the neural network model; receiving, by the plurality of neurons, input signals; and generating, by the plurality of neurons, output signals.

In some implementations, the output signals are determined by probability distributions for outputting a predetermined value.

In some implementations, the probability distributions are controlled by at least one of (i) the voltage biases applied on the plurality of SPADs, (ii) a time duration of which the voltage biases vary, (iii) an intensity of an optical signal that is incident on one or more SPADs of the plurality of SPADs, or (iv) temperature.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIG. 1 illustrates an example neural network model.

FIG. 2 illustrates an example of a simplified optoelectronic circuitry for implementing a neuron in a neural network model.

FIG. 3A illustrates a cross-sectional view of an example photodetector.

FIG. 3B illustrates a cross-sectional view of an example photodetector.

FIG. 4 illustrates a cross-sectional view of an example photodetector.

FIG. 5 illustrates an example weight matrix circuitry.

FIG. 6 illustrates a flowchart of an example process for performing computations on a neural network model using optoelectronic circuitry.

Like reference numbers and designations in the various drawings indicate like elements.

### DETAILED DESCRIPTION

A neural network is a computational model designed to recognize patterns and solve complex problems by learning from data. The neural network can have layers of interconnected nodes (neurons), each of which performs simple computations. The connections (synapse) between these neurons have weights that are adjusted as the neural network learns, enabling the processing and interpretation of complex data inputs.

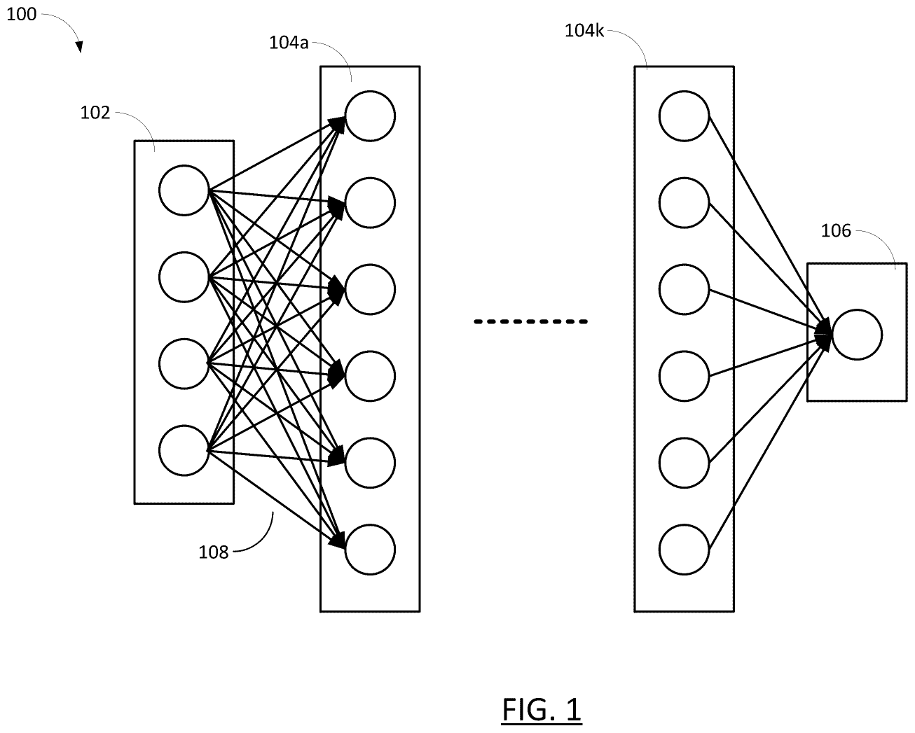

FIG. 1 shows an example neural network model 100. The neural network model 100 includes an input layer 102, one or more k hidden layers 104a-104k, an output layer 106, and weight matrices, e.g., a weigh matrix 108 between the input layer 102 and the first hidden layer 104a. The input layer 102 receives preprocessed data represented as numerical vectors. Each of the one or more k hidden layers 104a-104k contains neurons trained and implemented by known techniques (e.g., backpropagation for weight assignments, etc.). The output layer 106 is configured to produce an output that represents the processed input. In the weight matrix 108, each arrow corresponds to an associated weight value. The value going into the node is distributed according to the values of the weights.

The present disclosure describes stochastic neural networks implemented using optoelectronic circuitry having single-photon avalanche diodes (SPAD), which provides technical advantages such as lower power consumption, massively parallel and programmable hardware computing, and CMOS-compatibility. A stochastic neural network is a type of neural network that incorporates randomness into its operations or structure. Unlike traditional neural networks, which operate deterministically, stochastic neural networks introduce randomness as a fundamental component. As an example, the input and the output of a neuron in stochastic neural networks may be treated as random variables with specific distributions. This can help in exploring a more diverse set of possibilities during training or inference, leading to potentially better generalization on unseen data with lower system power.

An SPAD is a highly sensitive semiconductor device that can detect and measure single photons. An SPAD operates under a reverse-bias above its breakdown voltage, where a single photon hitting the light absorption region can trigger an electron-hole pair. This electron-hole pair is then accelerated by an electric field, colliding with other atoms to create more electron-hole pairs, leading to an avalanche of charge carriers. A germanium-silicon (GeSi) SPAD that can operate in room temperature has been reported (Na, N., Lu, Y C., Liu, Y H. et al. Room temperature operation of germanium-silicon single-photon avalanche diode. Nature (2024), incorporated herein by reference), which paves the way towards many new applications. Importantly, the photon-count rate (PCR) and the dark count rate (DCR) of a GeSi SPAD can be controlled by parameters such as the illumination condition, the bias voltages applied to the SPAD, and/or the input pulse duration. Since PCR and DCR are average rates of registered counts, there is a randomness in each registered count. Accordingly, a random variable may be implemented by controlling the PCR and/or the DCR of a GeSi SPAD. Note that although the present disclosure uses GeSi SPADs as primary examples for implementing stochastic neural networks, SPADs of other materials such as group IV or group III-V semiconductors may be used as long as their PCR and DCR can be controlled using the same principles as described in the present disclosure.

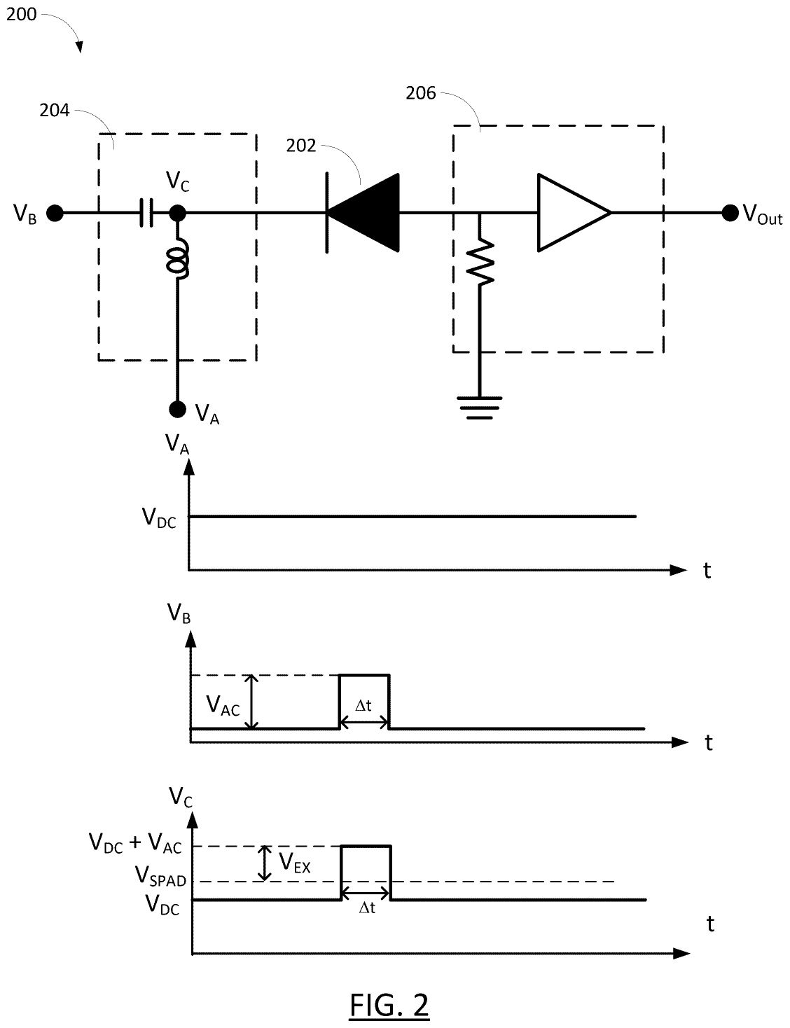

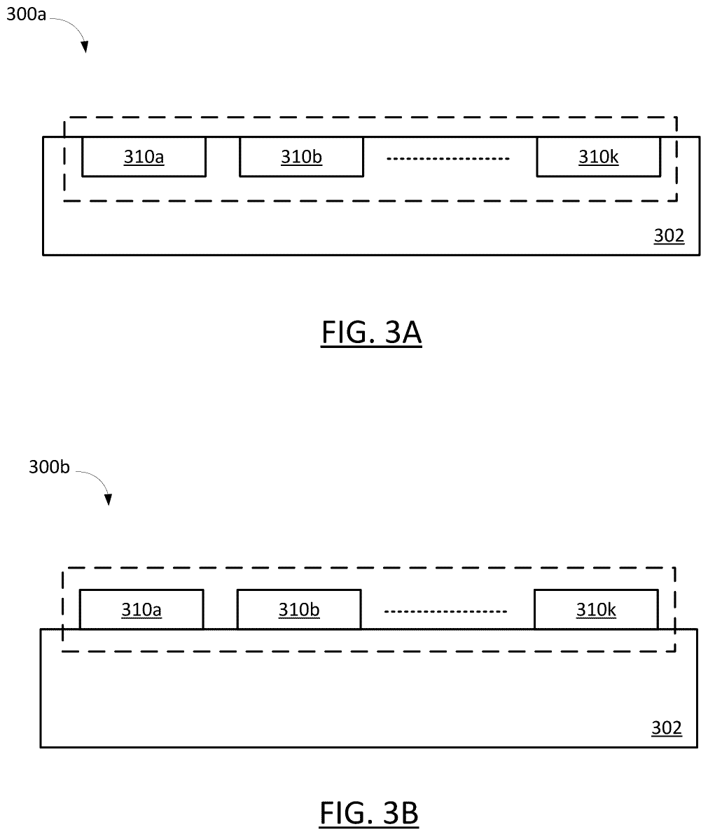

FIG. 2 illustrates an example of a simplified optoelectronic circuitry 200 for implementing a neuron in a neural network model (e.g., a stochastic neural network). The neural network model can be similar to, or same as, the neural network model 100 of FIG. 1. In some implementations, the circuitry 200 includes an SPAD 202 (e.g., the SPAD photodetector 300a/300b described in reference to FIGS. 3A-3B), where the input of the SPAD 202 is coupled to a bias circuitry 204 and the output of the SPAD 202 is coupled to an amplification circuitry 206.

The bias circuitry 204 is configured to generate a bias voltage for biasing the SPAD 202. In some implementations, the bias circuitry 204 may include a bias tee circuitry, where an inductor in the bias tee circuitry is coupled to a first input voltage V_{A}, and a capacitor in the bias tee circuitry is coupled to a second input voltage V_{B}. As shown in FIG. 2 as an example, the first input voltage V_{A} is a variable DC voltage signal (or alternatively, a reference voltage signal) with an amplitude of V_{DC}, and the second input voltage V_{B} is a pulsed voltage signal with a peak amplitude of V_{AC} and a pulse width Δt. In some implementations, the second input voltage V_{B} may be generated from a periodic source such as a clock signal generator. The third input voltage V_{C} is a combined voltage signal with the DC component V_{DC} and a peak amplitude of {V_{DC}+V_{AC}}.

The SPAD 202 has a threshold breakdown voltage V_{SPAD}. If the SPAD 202 is operated at a voltage equal to or above V_{SPAD}, the Geiger mode condition (or the avalanche breakdown regime) for the SPAD 202 is met. When there is no pulse present in the third input voltage V_{C}, the SPAD 202 is operated at V_{DC} that is below V_{SPAD}, and therefore the Geiger mode condition is not met. On the other hand, when the pulse is present in the third input voltage V_{C}, the SPAD 202 is operated at {V_{DC}+V_{AC}} that is over V_{SPAD}, and therefore the Geiger mode condition is met. The likelihood of a SPAD avalanche breakdown increases as the value of V_{EX} increases beyond V_{SPAD}, which can be controlled with either the DC voltage signal V_{DC} and/or the peak amplitude of the V_{AC}.

When a charge-carrier avalanche breakdown occurs, the SPAD 202 is configured to output an electrical current, and the amplification circuitry 206 is configured to generate an amplified voltage signal based on the current output from the SPAD 202. The amplified voltage signal can be represented as a binary logic 1. The event of which whether an avalanche breakdown occurs may be expressed as a random variable X, where two potential outcomes are possible:

$$X ∈ \{ \begin{matrix}0 , no avalanche breakdown \\ 1 , avalanche breakdown occurs\end{matrix} ; \qquad ( 1 ) .$$

In some cases, when there is no light incident on a SPAD, an avalanche breakdown may still occur due to dark currents in the SPAD. Notably, the dark count rate (DCR) associated with a GeSi SPAD can be controlled by various factors, including the bias applied to the GeSi SPAD (e.g., V_{EX}). As an example, the probability of whether an avalanche breakdown occurs when no light is present may be expressed as:

$${P}_{dark} ( X = 0 \vert {V}_{EX} ) = exp ( - D C R \times Δ t ) ; and \qquad ( 2 ) ,$$

$${P}_{dark} ( X = 1 \vert {V}_{EX} ) = 1 - exp ( - D C R \times Δ t ) ; \qquad ( 3 ) .$$

On the other hand, when there is light incident on an SPAD, an avalanche breakdown occurs predominantly as a function of the photon count rate (PCR). As an example, the probability of which whether an avalanche breakdown occurs when there is light present may be expressed as:

$${P}_{light} ( X = 0 \vert {V}_{EX} ) = exp ( - P C R \times Δ t ) ; \\ and \qquad ( 4 ) ,$$

$${P}_{light} ( X = 1 \vert {V}_{EX} ) = 1 - exp ( - P C R \times Δ t ) ; \qquad ( 5 ) .$$

Accordingly, the probability distribution associated with the SPAD may be controlled by one or more of (i) a bias applied to the SPAD, (ii) a time duration of which the bias varies in time, (iii) whether an optical signal is incident on the particular SPAD, and/or the intensity of the optical signal. In some cases, saturation may be defined as a probability that meets or exceeds a threshold value, e.g., P_{light}(X=1|V_{EX}) reaching a number close to 1 (e.g., 0.9). In some implementations, the probability distributions may be linearly activated (approximately) by adjusting the bias of a SPAD below saturation. In some implementations, the probability distributions may be non-linearly activated by switching an SPAD below/above saturation. Using GeSi SPAD has further technical advantages because of its higher DCR (as compared to silicon (Si) SPAD) due to defects arisen from the lattice mismatch between Ge and Si, and negligible after-pulsing probability (APP) due to high-quality Si. In some implementation, the SPAD 202 can be replaced by multiple SPADs connected in parallel so that the outcomes of the net random variables are more than just binary.

FIGS. 3A and 3B show examples of a SPAD photodetector array 300a/300b, respectively. The SPAD photodetector array 300a/300b can be implemented in a neural network model (e.g., the neural network model 100 of FIG. 1). The SPAD photodetector array 300a/300b includes a substrate 302 (e.g., silicon or another substrate material) and k pixels 310a-310k along a direction, where each of the k pixels 310a-310k may be an SPAD having germanium (or germanium containing tin) absorption regions (e.g., the SPAD 202 of FIG. 2).

Referring to FIG. 3A, in some implementations, the k pixels 310a-310k may be partially or fully embedded in the substrate 302 (e.g., epitaxially grown in an etched trench in the substrate 302). Referring to FIG. 3B, in some implementations, the k pixels 310a-310k may be formed as a mesa on a surface of the substrate 302 (e.g., epitaxially grown over the surface of the substrate 302, followed by an etch to form the pixels). In some implementations, the SPAD photodetector array 300a/300b may be a one-dimensional array (e.g., 1×k pixels), where k is an integer. In some implementations, the SPAD photodetector array 300a/300b may be a two-dimensional array (e.g., m×k pixels), where m, k are integers.

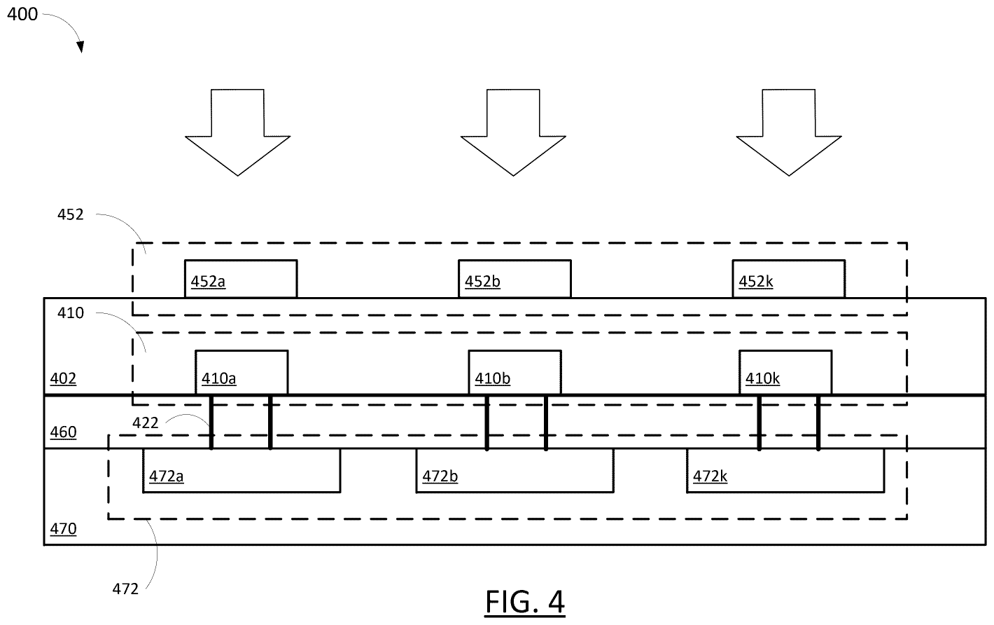

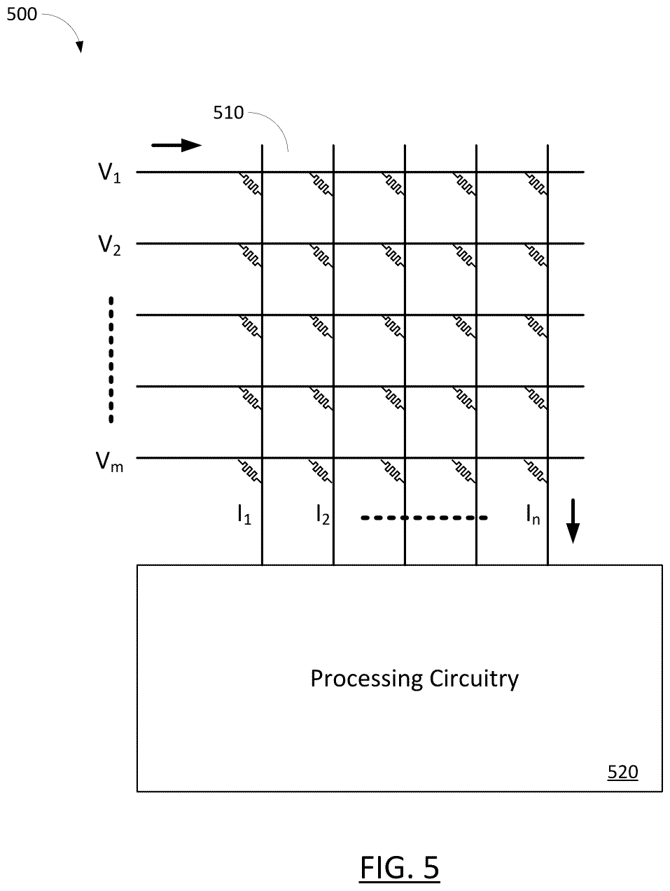

FIG. 4 shows an example of an SPAD photodetector array 400. The SPAD photodetector array 400 can be implemented in a neural network model (e.g., the neural network model 100 of FIG. 1). The photodetector array 400 includes a first substrate 402 (e.g., silicon substrate) having k pixels 410a-410k (e.g., k pixels 310a-310k described in reference to FIG. 3A or 3B) along a direction. The k pixels 410a-410k can be referred to generally as pixels 410 and individually as pixel 410. The first substrate 402 is directly or flipped bonded to a second substrate 470 (e.g., a silicon substrate) having circuitry 472, with a bonding interface 460. The bonding interface 460 may include a dielectric material (e.g., oxide), or a metallic material (e.g., copper), or a mix between a dielectric material and a metallic material. In some implementations, the circuitry 472 may include k individual circuitry that each is electrically coupled to a corresponding pixel 410 via wires 422. The circuitry 472 may include the bias circuitry 204 of FIG. 2, the amplification circuitry 206 of FIG. 2, the weight matrix circuitry 500 (as described in reference to FIG. 5), and/or other processing circuitry for neural network implementations.

In some implementations, the photodetector 400 may include an optical structure 452. The optical structure 452 may be one or more layers of structures that focus, direct, filter, pass, block, and/or otherwise manipulate an optical signal that enters the k pixels 410. In some implementations, the optical structure 452 may include k optical structures 452a-452k that each is optically coupled to a corresponding pixel 410. For example, an optical structure 452a may be an optical lens that can be implemented using a meta-surface lens (e.g., with materials such as Si nitride, Ti oxide, Ta oxide, Si, or a combination of thereof) or a convex lens (e.g., with materials such as polymer or Si, or a combination of therefore). As another example, an optical structure 452a may be a combination of a band pass filter and an optical lens, where the band pass filter may be implemented using a meta-surface filter (e.g., with materials such as Si nitride, Ti oxide, Ta oxide, Si, or a combination of thereof), a Fabry-Perot interferometer (e.g., with materials such as Si dioxide, Si nitride, Si, or combination of thereof), or an absorption material (e.g., with materials such as optical dyes), and the optical lens may be implemented using a meta-surface or a convex lens.

For an SPAD that is implemented to amplify only dark current in a neural network (e.g., a neuron in a hidden layer), the optical structure may include an absorptive or reflective material that blocks the light incident to the SPAD. For an SPAD that is implemented to amplify both photo current and dark current in a neural network (e.g., a neuron in an input layer), the optical structure may include an optical filter that transmits desirable light incident to the SPAD. Referring to FIG. 1 as an example, an optical filter may be arranged on SPADs associated with the input layer 102, and an optical blocker may be arranged on SPADs associated with the hidden layers 104a-104k and the output layer 106. The input layer 102 may therefore take an optical image as an input, and the neural network 100 may process the optical image accordingly (e.g., inference, forward training, etc.). As another example, an optical blocker may be arranged on SPADs associated with the input layer 102, the hidden layers 104a-104k and the output layer 106. Here, the input layer 102 takes only electrical signals as inputs, and the neural network 100 may process the electrical inputs accordingly (e.g., inference, forwarding training, etc.).

FIG. 5 shows an example weight matrix circuitry 500. The weight matrix circuitry 500 can be implemented in a neural network model (e.g., the neural network model 100 of FIG. 1). The weight matrix circuitry 500 includes a cross-bar mesh 510 and a processing circuitry 520. In some cases, the cross-bar mesh 510 is configured to receive m voltage signals (e.g., from m SPADs outputs of a previous neural network layer) and to generate n current or n voltage signals. Memory elements such as floating-gate memory, phase-change memory, resistive random-access memory, memristor, MOS capacitor, charge coupled device, or any other suitable memory elements may be used at the intersections of the cross-bar mesh 510 to achieve a voltage-to-current or a voltage-to-voltage matrix multiplication.

The processing circuitry 520 can be configured to receive and process the n current signals or n voltage signals from the cross-bar mesh 510. As an example, the processing circuitry 520 may include a transimpedance amplifier (TIA) circuitry configured to convert the current signals to voltage signals. The processing circuitry 520 may further include an analog-to-digital (ADC) circuitry configured to generate digitized voltage signals based on the analog voltage signals from the TIA or from the n voltage signals. The processing circuitry 520 may further include a digital-to-analog (DAC) circuitry configured to generate analog voltage signals based on the digitized voltage signals from the ADC to clean up noises of the analog voltage signals from the TIA or from the n voltage signals. In some implementations, the analog voltage signals from the TIA or from the n voltage signals can be further fed to the bias circuitry 204 of SPADs in the next layer of neurons (feed-forward) or even in the same layer of neurons (re-current), and thus influence the probability distribution associated with the SPADs. In some implementations, the processing circuitry 520 may include an integrator/threshold/reset circuitry configured to implement a membrane potential of a spiking function by accumulating the received input signals and generate an output signal when certain threshold is met. The processing circuitry 520 may include any other suitable circuitry for processing information generated by a neuron in a neural network.

In some implementations, a neural network may be implemented as a deep-belief neural network, where the SPADs are non-linearly activated, and the outputs are provided to a cross-bar mesh implemented by memory elements. In some other implementations, a neural network may be implemented as a spiking neural network, where the SPADs are linearly activated, and the outputs are provided to a cross-bar mesh implemented by nonlinear memristor. In some other implementations, a neural network may be implemented as a spiking neural network, where the SPADs are linearly activated, and the outputs are provided to a cross-bar mesh implemented by memory elements followed by an integrator/threshold/reset nonlinear circuitry.

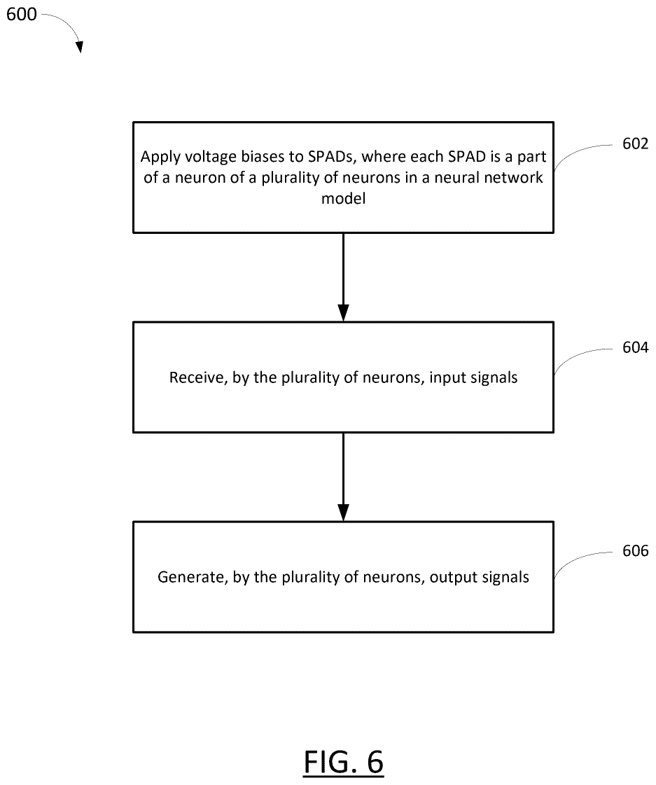

FIG. 6 shows an example flowchart of a process 600 for performing computations on a neural network model using optoelectronic circuitry, where the process 600 can be implemented by a neural network model such as the neural network model 100 of FIG. 1, as an example.

The process 600 can include one or more steps or operations: at 602, applying voltage biases (e.g., V_{A} and V_{B} resulting into V_{C} in reference to FIG. 2) to a plurality of SPADs (e.g., SPAD 202 of FIG. 2), where each SPAD of the plurality of SPADs is a part of a neuron of a plurality of neurons in the neural network model; at 604, receiving, by the plurality of neurons, input signals (e.g., V_{B}); and at 606, generating, by the plurality of neurons, output signals (e.g., Vout), where the output signals are determined by probability distributions for outputting a predetermined value (e.g., logical 0 or 1).

Unless otherwise specified, as used herein, the terms “photodetector”, “optical sensor”, “optical sensing apparatus”, or other similar terms can include a device that has been designed and/or operated as a photodiode (PD), an avalanche photodiode (APD), a single-photon avalanche diode (SPAD), or a locked-in PD (LIPD).

As used herein, the terms such as “first”, “second”, “third”, “fourth” and “fifth” describe various elements, components, regions, layers and/or sections, these elements, components, regions, layers and/or sections should not be limited by these terms. These terms may be only used to distinguish one element, component, region, layer or section from another. The terms such as “first”, “second”, “third”, “fourth” and “fifth” when used herein do not imply a sequence or order unless clearly indicated by the context. The terms “photo-detecting”, “photo-sensing”, “light-detecting”, “light-sensing” and any other similar terms can be used interchangeably.

Spatial descriptions, such as “above”, “over,”, “under”, “top”, and “bottom” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein and not otherwise defined, the terms “substantially” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the concepts have been described by way of examples and in terms of embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optoelectronic circuitry for performing computations of a neural network model, the optoelectronic circuitry comprising:
a plurality of single-photon avalanche diodes (SPADs),
wherein the neural network model comprises a plurality of layers,
wherein each of the plurality of layers comprises a plurality of neurons, and
wherein each SPAD of the plurality of SPADs is configured to:
receive a respective input representing an input to a corresponding neuron of the plurality of neurons; and
generate a respective output representing an output from the corresponding neuron.

2. The optoelectronic circuitry of claim 1, wherein the plurality of SPADs comprise germanium-silicon (GeSi) SPADs.

3. The optoelectronic circuitry of claim 2, wherein the plurality of SPADs are arranged in a one-dimensional array or a two-dimensional array on a substrate.

4. The optoelectronic circuitry of claim 1, wherein the neural network model comprises a stochastic neural network, and wherein each of the plurality of neurons is associated with a respective probability distribution for outputting a predetermined value.

5. The optoelectronic circuitry of claim 4, wherein the respective probability distribution associated with a corresponding SPAD of the plurality of SPADs is controlled by a bias applied to the corresponding SPAD.

6. The optoelectronic circuitry of claim 5, wherein the probability distribution is activated linearly by ranging the bias applied on the corresponding SPAD to be below a saturation regime of the corresponding SPAD.

7. The optoelectronic circuitry of claim 5, wherein the probability distribution is activated non-linearly by ranging the bias applied on the corresponding SPAD to be from below a saturation regime of the corresponding SPAD to beyond the saturation regime.

8. The optoelectronic circuitry of claim 5, wherein the probability distribution associated with the corresponding SPAD is further controlled by at least one of (i) a time duration of which the bias varies in time, (ii) an intensity of an optical signal that is incident on the intensity SPAD, or (iii) temperature.

9. The optoelectronic circuitry of claim 1, further comprising:
a plurality of bias circuitries electrically coupled to the plurality of SPADs, wherein each of the plurality of bias circuitries is configured to generate a respective bias voltage for biasing a corresponding SPAD.

10. The optoelectronic circuitry of claim 9, wherein each of the plurality of bias circuitries is configured to receive a reference voltage and an input voltage, and wherein the bias voltage is generated by combining a direct current (DC) component of the reference voltage and an alternating current (AC) component of the input voltage.

11. The optoelectronic circuitry of claim 1, further comprising:
a plurality of amplification circuitries electrically coupled to the plurality of SPADs, wherein each of the plurality of amplification circuitries is configured to generate a respective amplified voltage signal based on a corresponding output from a corresponding SPAD.

12. The optoelectronic circuitry of claim 11, further comprising:
a memory cross bar electrically coupled to the plurality of amplification circuitries, wherein the memory cross bar is configured to perform a voltage-to-current or a voltage-to-voltage matrix calculation based on the respective amplified voltage signals from the plurality of amplification circuitries.

13. The optoelectronic circuitry of claim 12, further comprising:
a plurality of transimpedance amplifier (TIA) circuitries configured to generate analog voltage signals based on current outputs of the memory cross bar.

14. The optoelectronic circuitry of claim 13, further comprising:
a plurality of analog-to-digital converter (ADC) circuitries configured to generate digitized voltage signals based on the analog voltage signals from the plurality of transimpedance amplifier (TIA) circuitries or from voltage outputs of the memory cross bar.

15. A neural network model, comprising:
a plurality of layers,
wherein each of the plurality of layers comprises a plurality of neurons, and
wherein each neuron of the plurality of neurons comprises a SPAD configured to:
receive a bias voltage; and
generate an output based on a probability distribution for outputting a predetermined value, wherein the probability distribution is controlled by at least the bias voltage.

16. The neural network model of claim 15,
wherein the plurality of layers comprises a first layer and a second layer, and
wherein outputs of neurons of the first layer are electrically coupled to an input of each neuron of the second layer.

17. The neural network model of claim 15, wherein the probability distribution is further controlled by at least one of (i) a time duration of which the bias varies in values, (ii) an intensity of an optical signal that is incident on the SPAD, or (iii) temperature.

18. A method for performing computations on a neural network model, the method comprising:
applying voltage biases to a plurality of SPADs, wherein each SPAD of the plurality of SPADs is a part of a neuron of a plurality of neurons in the neural network model;
receiving, by the plurality of neurons, input signals; and
generating, by the plurality of neurons, output signals.

19. The method of claim 18, wherein the output signals are determined by probability distributions for outputting a predetermined value.

20. The method of claim 19, wherein the probability distributions are controlled by at least one of (i) the voltage biases applied on the plurality of SPADs, (ii) a time duration of which the voltage biases vary, (iii) an intensity of an optical signal that is incident on one or more SPADs of the plurality of SPADs, or (iv) temperature.
